(19) United States
(12) Patent Application Publication
(10) Pub. No.: US 2024/0168805 A1
(43) Pub. Date: May 23, 2024

(54) AUTOMATED AD-HOC TASK SCHEDULING USING TASK VELOCITY

(71) Applicant: INTERNATIONAL BUSINESS MACHINES CORPORATION, Armonk, NY (US)

(72) Inventors: Wesley Ip, Arlington, TX (US); Alexandra M. Isaly, Lighthouse Point, FL (US); Ryan Michael Sparks, Norman, OK (US); Zachary A. Silverstein, Georgetown, TX (US)

(21) Appl. No.: 17/989,659

(22) Filed: Nov. 17, 2022

(51) Int. Cl. G06F 9/50

(52) U.S. Cl. CPC G06F 9/5027

(57) ABSTRACT

A computer hardware system includes a machine learning engine and a hardware processor configured to perform the following executable operations. A plurality of electronic communications between client devices including a first client device of a first user are monitored. Ad-hoc tasks for the first user are identified using the machine learning engine by performing natural language processing of the plurality of electronic communications. Platforms associated with the ad-hoc tasks are monitored to determine a task completion status of the identified ad-hoc tasks. A time slot for performing the ad-hoc tasks by the first user is automatically reserved within a calendar/scheduling application of the first client device based upon a task velocity score.

### BACKGROUND

The present invention relates to automated scheduling of tasks in a calendar/scheduling application, and more specifically, to using a task velocity determination to inform when to add automatically-identified ad-hoc tasks to the calendar/scheduling application.

In a modern work environment, users can be overrun with ad-hoc tasks. Unlike scheduled tasks (e.g., a weekly meeting), an ad-hoc task is typically a one-off task that is to be performed only once and the occurrence of these ad-hoc tasks is unpredictable. Examples of ad-hoc tasks include a user being asked, during a meeting, to send a meeting invite to another user or the user being asked to request information from another user via email. These types of tasks typically take little time to accomplish and consequently are rarely proactively scheduled by a user in a calendar/scheduling application. However, because these ad-hoc tasks generally take so little time (and as a result can be deemed to be minor or insignificant), the user can easily forget to perform these ad-hoc tasks. Additionally, the oftentimes low priority of these ad-hoc tasks exacerbates these ad-hoc tasks being overlooked/forgotten.

### SUMMARY

A computer-implemented process using computer hardware system having a machine learning engine includes the following executable operations. A plurality of electronic communications between client devices including a first client device of a first user are monitored. Ad-hoc tasks for the first user are identified using the machine learning engine by performing natural language processing of the plurality of electronic communications. Platforms associated with the ad-hoc tasks are monitored to determine a task completion status of the identified ad-hoc tasks. A time slot for performing the ad-hoc tasks by the first user is automatically reserved within a calendar/scheduling application of the first client device based upon a task velocity score.

In other aspects of the process, the identifying the ad-hoc tasks includes identifying for each of the ad-hoc tasks: an activity to be performed, a platform with which the activity is to be performed, a user assigned to the activity, a timeframe during which the ad-hoc task is to be performed, and an urgency level assigned to the ad-hoc task. The machine learning engine is trained based upon the identifying. The task velocity score is determined based upon task velocity and task backlog. A graphical user interface of the first client device is configured to allow the first user to select applications to be monitored for the electronic communications. A notification is pushed to an application executing with the first client device based upon the application being a platform for performing at least one of the identified ad-hoc tasks. The automatic reserving includes associating at least a portion of the identified tasks with the time slot.

A computer hardware system includes a machine learning engine and a hardware processor configured to perform the following executable operations. A plurality of electronic communications between client devices including a first client device of a first user are monitored. Ad-hoc tasks for the first user are identified using the machine learning engine by performing natural language processing of the plurality of electronic communications. Platforms associated with the ad-hoc tasks are monitored to determine a task completion status of the identified ad-hoc tasks. A time slot for performing the ad-hoc tasks by the first user is automatically reserved within a calendar/scheduling application of the first client device based upon a task velocity score.

In other aspects of the computer hardware system, the identifying the ad-hoc tasks includes identifying for each of the ad-hoc tasks: an activity to be performed, a platform with which the activity is to be performed, a user assigned to the activity, a timeframe during which the ad-hoc task is to be performed, and an urgency level assigned to the ad-hoc task. The machine learning engine is trained based upon the identifying. The task velocity score is determined based upon task velocity and task backlog. A graphical user interface of the first client device is configured to allow the first user to select applications to be monitored for the electronic communications. A notification is pushed to an application executing with the first client device based upon the application being a platform for performing at least one of the identified ad-hoc tasks. The automatic reserving includes associating at least a portion of the identified tasks with the time slot.

A computer program product includes computer readable storage medium having stored therein program code. The program code, which when executed by a computer hardware system including a machine learning engine, cause the computer hardware system to perform the following operations. A plurality of electronic communications between client devices including a first client device of a first user are monitored. Ad-hoc tasks for the first user are identified using the machine learning engine by performing natural language processing of the plurality of electronic communications. Platforms associated with the ad-hoc tasks are monitored to determine a task completion status of the identified ad-hoc tasks. A time slot for performing the ad-hoc tasks by the first user is automatically reserved within a calendar/scheduling application of the first client device based upon a task velocity score.

In other aspects of the computer program product, the identifying the ad-hoc tasks includes identifying for each of the ad-hoc tasks: an activity to be performed, a platform with which the activity is to be performed, a user assigned to the activity, a timeframe during which the ad-hoc task is to be performed, and an urgency level assigned to the ad-hoc task. The machine learning engine is trained based upon the identifying. The task velocity score is determined based upon task velocity and task backlog. A graphical user interface of the first client device is configured to allow the first user to select applications to be monitored for the electronic communications. A notification is pushed to an application executing with the first client device based upon the application being a platform for performing at least one of the identified ad-hoc tasks. The automatic reserving includes associating at least a portion of the identified tasks with the time slot.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 is block diagram illustrating an architecture of an example automated task system according to an embodiment of the present invention.

FIG. 2 illustrating an example method using the architecture of FIG. 1 according to an embodiment of the present invention.

FIG. 3 is a block diagram illustrating an example of computer environment for implementing portions of the methodology of FIG. 2.

### DETAILED DESCRIPTION

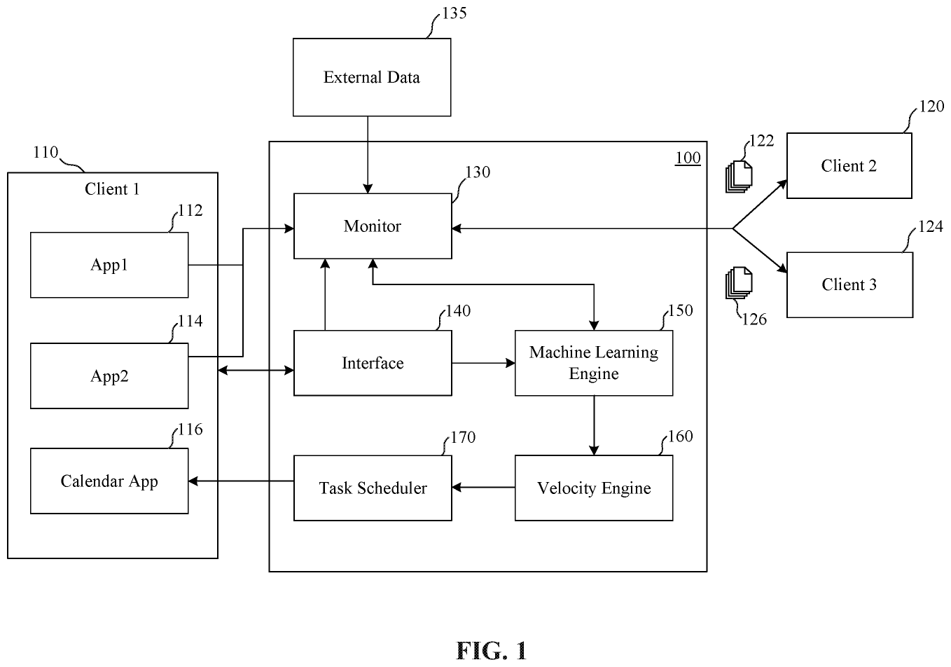

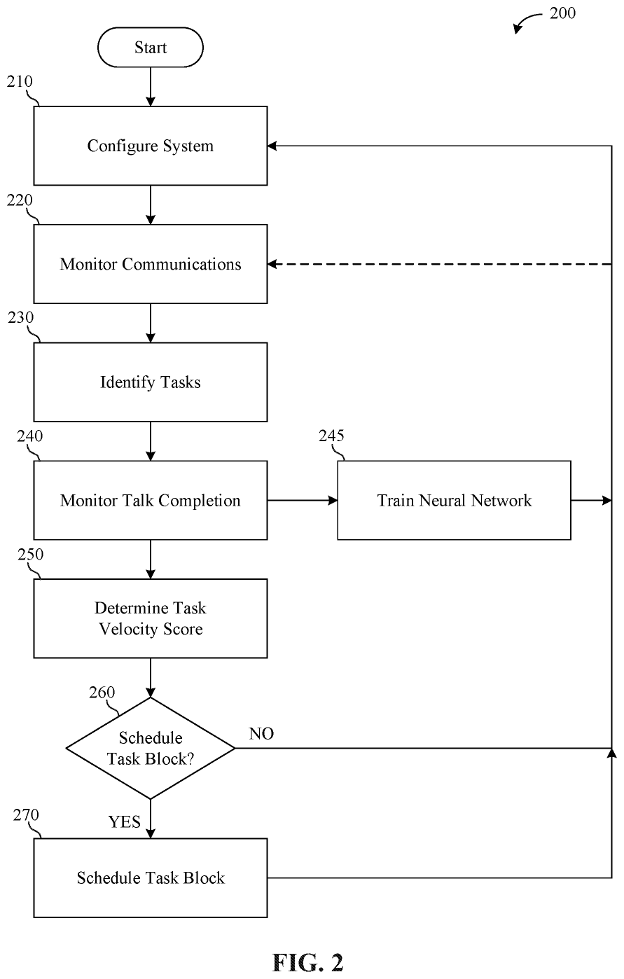

Reference is made to FIG. 1 and FIG. 2, which respectively illustrate an automated task scheduling system 100 and methodology 200 for using a task velocity determination to inform when to add automatically-identified ad-hoc tasks to a calendar/scheduling application. Although illustrated as being separate from a first client device 110 of a first user, one or more components of the task scheduling system 100 can be found within the first client device 110.

Although not limited in this particular manner, operation of the automated task scheduling system 100 includes monitoring a plurality of electronic communications 122, 126 between client devices 110, 120, 124 including the first client device 100 of the first user. Ad-hoc tasks for the first user are identified using a machine learning engine 150 by performing natural language processing of the plurality of electronic communications 120, 124. Platforms 112, 114 associated with the ad-hoc tasks are monitored to determine a task completion status of the identified ad-hoc tasks. A time slot for performing the ad-hoc tasks by the first user is automatically reserved within a calendar/scheduling application 116 of the first client device 110 based upon a task velocity score. A more detailed description of these operations is discussed below.

In 210, the process 200 begins with the task scheduling system 100 being configured by a first user of the first client device 110 via the interface 140. The interface 140 can, for example, interact with a graphical user interface within the client device 110 that allows the first user to customize certain configuration aspects of the task scheduling system 100. These configuration aspects can include identifying the particular applications to be monitored (e.g., APP1 112 and APP2 114) and/or other clients (e.g., 120, 124) to be monitored. These applications 112, 114 can include communication applications that generate electronic messages 122, 126 that are sent to other client device 120, 124. Illustrative examples of these applications 112, 114 include email clients, productivity software, social networking applications, and video conferencing software. The interface 140 can also allow the first user to either opt into or opt out of using the methodology 200.

In 220, the monitor 130 is configured to automatically monitor electronic communications 122, 126 between the first client device 110 and other devices (e.g., client device 120, 124). Many types of approaches are known to be capable of automatically monitoring electronic communications 122, 126 between electronic devices, and the monitor 130 is not limited as to a particular approach. For example and in certain aspects, the monitor 130 can access application programming interfaces (APIs) respectively associated with the applications 112, 114 and/or other client device 120, 124 to retrieve electronic communications 122, 126 associated therewith. The electronic communications 122, 126 can include but are not limited to emails, texts, and video messages. The electronic communications 122, 126 can also include both communications inbound to the first client device 110 or outbound from the first client device 110. As discussed above, the particular applications to be monitored (e.g., APP1 112 and APP2 114) and/or other client devices (e.g., 120, 124) to be monitored can be identified as part of the initial (or subsequent) configuration of the task scheduling system 100.

In 230, tasks to be performed by the first user are identified from the electronic communications 122, 126 obtained by the monitor 130. Many types of approaches are known to be capable of automatically determining tasks from electronic communications 122, 126 and the methodology 200 is not limited as to a particular approach. For example, the contents of the electronic communications 122, 126 can be analyzed using natural language processing (e.g., in machine learning engine 150) to identify phrases associated with a task. For example, an email that contains “Can you send me a meeting invite” can be interpreted as a task request involving the action of generating a calendar invite for the meeting and sending that calendar invite from the first user to the person requesting the meeting invite. As another example, a video conference may include a statement of “Avery, could you add the review team to the XYZ project channel?,” which indicates that members of the “review team” are to be added to a particular channel (i.e., XYZ project) in a productivity application.

As used herein, the term “task” refers to a computer/technology-implemented activity to be performed using a particular type of platform (i.e., application/technology) and assigned to a particular user. The term “task” is being used in place of “ad-hoc task,” which differs from a previously-scheduled task in that the “ad-hoc” task was not previously scheduled. The identification of a task can also include the identification of “task information,” which as defined herein includes at least: (i) an identification of the task itself (i.e., what activity(s) is/are required to perform the task including completion criteria), (ii) an identification of a user assigned to the task, (iii) an identification of the platform (i.e., technology/application) used to implement the task. For example, a text message directed to a particular user (i.e., Avery) of “please call Ryan about the meeting” can generate task information of (i) the task being to make a phone call, (ii) the task is assigned to Avery, and (iii) the technology used to implement the task is a phone. This task information can be stored in a data structure associated with the first user (e.g., the assigned user) and the task. Although the user assigned to the task is discussed herein as referring to the first user, a determination can be made that the task is to be assigned to a different user (e.g., a user associated with the other client devices 120, 124).

The task information can also include: (iv) a time frame by which to complete the task. If the electronic communication 122, 126 does not specify a particular time frame, the task scheduling system 100 can add an estimate timeframe to the task information using the machine learning engine 150. The task information can further include: (v) an urgency level for the task. Many types of approaches are known as being capable of determining an urgency level for a task, and the task scheduling system 100 is not limited as to a particular approach. However, in certain aspects, the urgency level for the task can be dynamically based upon how long ago the electronic communication, which was the basis for the task, was sent. Additional to or alternatively, the urgency level for a task can be based upon weighted connotations of descriptive words associated with the task. For example, words/phrases such as “critical,” “severe,” or “as soon as possible” can implicate a greater urgency for the particular task. Another additional/alternative factor that can be used to modify the urgency level of the task is the existence of a repeated task, i.e., a task in which the request to complete the task has been repeated.

In 240, the monitor 130 is configured to monitor the applications 112, 114 and/or other client device 120, 124 to determine whether the previously-identified tasks have been accomplished (i.e., a task completion status). Although illustrated as being the same monitor 130 that monitors electronic communications in 220, the monitor 130 can be split into separate and distinct monitors depending upon whether the monitor 130 is monitoring for electronic communications 122, 126 or monitoring for the completion of the identified tasks. The monitor 130 can also be configured to monitor external data sources 135 to determine whether the previously-identified tasks have been accomplished. For example, if one of the tasks to be performed was to make a particular telephone call, the call logs of the telephone can be monitored for data indicative of the particular telephone call being made. A determination of whether the first user accomplishes a task can also be based upon a monitoring of platform-specific utilization (e.g., based upon CPU/GPU/memory usage for the specific platform).

In 245, a neural network (e.g., a convolutional neural network or recurrent neural network) associated with the machine learning engine 150 can be trained. As previously-discussed, different aspects of the neural network are configured to perform the natural language processing of the monitored communications, identify the individual tasks, and determine an amount of estimated completion time to associate with each of estimated tasks. For example, the identification of each individual task can be built from a pre-defined action list corresponding with software-level integration with specific platforms (e.g., specific devices and user applications). Also, the neural network can be trained to associate certain terminology (e.g., “email me,” “text me,” or “call me”) with certain applications/devices (e.g., email, text messaging, and phone).

Although not limited in this manner, the machine learning engine 150 can be trained data regarding past task requests to determine an appropriate time frame for the current task in the identified task request as part of the training of the neural network of the machine learning engine 150. For example, if the phrase “Hey can you add me to XYZ software” was encountered—followed by “Yes, I'll do that now” and then “Done” 25 minutes later, then the machine learning engine 150 can leverage that information to assign an estimated time of completion of the task “adding a person to XYZ software” as 25 minutes. As another example, the machine learning engine 150 can derive an estimated time of completion for a particular task based upon monitoring application level interaction of a first user with a platform associated with a particular task.

In 250, a task velocity score (TVS) is determined by the velocity engine 160. As used herein, the term “task velocity” (TV) refers to how quickly (e.g., on average) an assigned task is being performed. As also used herein, the term “task backlog” (TB) refers to an estimated amount of time it would take the first user to complete all of the previously-identified tasks that have yet to be completed. Although not limited in this manner, the estimated amount can be determined using the machine learning engine 150 trained using a history of prior tasks similar to those identified as being assigned to the first user and not yet completed. A “task velocity score” TVS is calculated based upon a combination of “task velocity” and “task backlog.” In certain aspects, the task velocity score is determined using the equation: TVS=∫TB/TV. By way of example, if the first user is completing the identified tasks in a timely manner, the task backlog would be relatively low, and the task velocity would be relatively high, which results in a relatively low task velocity score. However, if the first user is falling behind and not completing the identified tasks in a timely manner, the task backlog would be relatively high, and the task velocity would be relatively low, which results in a relatively high task velocity score. Additionally, different tasks can be weighted differently. For example, email s may be weighted differently than text messages.

In 260, a determination is made, based upon the task velocity score and/or task backlog, whether to schedule a block of time during which the first user can perform the identified tasks that have yet to be performed. If the determination is to schedule a block of time, the methodology 200 proceeds to 270. If not, the methodology loops back to either 210 or 220. The values by which the task velocity score and/or task backlog can be predetermined either by the first user during configuration or automatically determined by the machine learning engine 150. For example, the machine learning engine 150 can predict, based upon the frequency of past re-notifications (i.e., past repeated requests for a particular task) whether the task scheduler 170 timely scheduled a block of time for performing the identified tasks based upon a particular task velocity score (TVS) and/or task backlog (TB).

In 270, the task scheduler 170 is configured to interact with a calendar/scheduling application 116 of the first client device 110 to schedule within the calendar/scheduling application 116 a free block of time during which the first user can perform the identified tasks that have yet to be performed. In so doing, the task scheduler 170 evaluates available blocks of time (i.e., time slots) versus at least one of the task backlog (i.e., the estimated amount of time it would take the first user to complete all of the previously-identified tasks that have yet to be completed) and the individual urgency levels for each task (i.e., when the task should be completed by). In certain aspects, the task scheduler 170 associates a list of suggested incomplete tasks to be performed during the scheduled time.

The task scheduler 170 can also bundle the incomplete tasks into multiple different time slots. For example, the task scheduler 170 make select an earlier time slot for incomplete tasks that have an urgency level that requires performance of the tasks by a particular time and select a later time slot for incomplete tasks whose performance can be delayed. As another example, the task scheduler 170 can bundle tasks that involve the same platform together (e.g., all tasks that require the first user to make a phone call or all tasks that require the first user to send an email).

In addition to or alternatively, the task scheduler 170 can be configured to push a notification to perform one or more of the identified tasks to the first client device 110. For example, if the task requires a particular platform to be performed (e.g., APP 112), and the first user opens the APP 112, the task scheduler 170 can interface with the APP 112 to push a notification to the first user that the one or more of the identified tasks can be performed by the APP 112.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

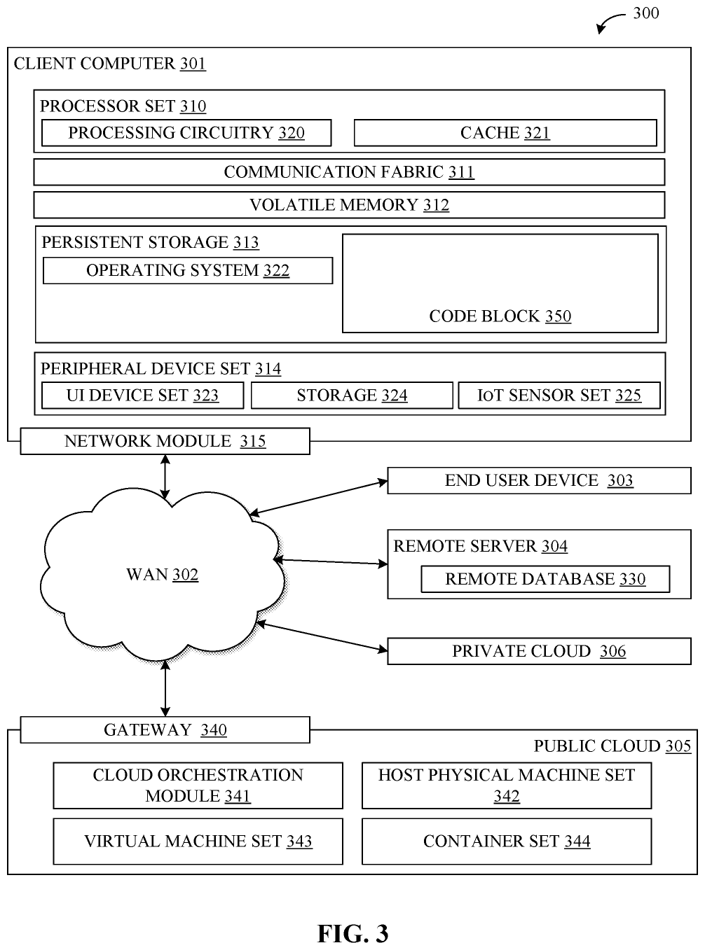

Referring to FIG. 3, computing environment 300 contains an example of an environment for the execution of at least some of the computer code involved in performing the inventive methods, such as code block 350 for implementing the operations of the task scheduling system 100. Computing environment 300 includes, for example, computer 301, wide area network (WAN) 302, end user device (EUD) 303, remote server 304, public cloud 305, and private cloud 306. In certain aspects, computer 301 includes processor set 310 (including processing circuitry 320 and cache 321), communication fabric 311, volatile memory 312, persistent storage 313 (including operating system 322 and method code block 350), peripheral device set 314 (including user interface (UI), device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

Computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. However, to simplify this presentation of computing environment 300, detailed discussion is focused on a single computer, specifically computer 301. Computer 301 may or may not be located in a cloud, even though it is not shown in a cloud in FIG. 3 except to any extent as may be affirmatively indicated.

Processor set 310 includes one, or more, computer processors of any type now known or to be developed in the future. As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In certain computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods discussed above in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in code block 350 in persistent storage 313.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Communication fabric 311 is the signal conduction paths that allow the various components of computer 301 to communicate with each other. Typically, this communication fabric 311 is made of switches and electrically conductive paths, such as the switches and electrically conductive paths that make up busses, bridges, physical input/output ports and the like. Other types of signal communication paths may be used for the communication fabric 311, such as fiber optic communication paths and/or wireless communication paths.

Volatile memory 312 is any type of volatile memory now known or to be developed in the future. Examples include dynamic type random access memory (RAM) or static type RAM. Typically, the volatile memory 312 is characterized by random access, but this is not required unless affirmatively indicated. In computer 301, the volatile memory 312 is located in a single package and is internal to computer 301. In addition to alternatively, the volatile memory 312 may be distributed over multiple packages and/or located externally with respect to computer 301.

Persistent storage 313 is any form of non-volatile storage for computers that is now known or to be developed in the future. The non-volatility of the persistent storage 313 means that the stored data is maintained regardless of whether power is being supplied to computer 301 and/or directly to persistent storage 313. Persistent storage 313 may be a read only memory (ROM), but typically at least a portion of the persistent storage 313 allows writing of data, deletion of data and re-writing of data. Some familiar forms of persistent storage 313 include magnetic disks and solid state storage devices. Operating system 322 may take several forms, such as various known proprietary operating systems or open source Portable Operating System Interface type operating systems that employ a kernel. The code included in code block 350 typically includes at least some of the computer code involved in performing the inventive methods.

Peripheral device set 314 includes the set of peripheral devices for computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet.

In various aspects, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some aspects, storage 324 may take the form of a quantum computing storage device for storing data in the form of qubits. In aspects where computer 301 is required to have a large amount of storage (for example, where computer 301 locally stores and manages a large database) then this storage 324 may be provided by peripheral storage devices designed for storing very large amounts of data, such as a storage area network (SAN) that is shared by multiple, geographically distributed computers. Internet-of-Things (IoT) sensor set 325 is made up of sensors that can be used in IoT applications. For example, one sensor may be a thermometer and another sensor may be a motion detector.

Network module 315 is the collection of computer software, hardware, and firmware that allows computer 301 to communicate with other computers through a Wide Area Network (WAN) 302. Network module 315 may include hardware, such as modems or Wi-Fi signal transceivers, software for packetizing and/or de-packetizing data for communication network transmission, and/or web browser software for communicating data over the internet. In certain aspects, network control functions and network forwarding functions of network module 315 are performed on the same physical hardware device. In other aspects (for example, aspects that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any Wide Area Network (for example, the internet) capable of communicating computer data over non-local distances by any technology for communicating computer data, now known or to be developed in the future. In some aspects, the WAN 302 ay be replaced and/or supplemented by local area networks (LANs) designed to communicate data between devices located in a local area, such as a Wi-Fi network. The WAN 302 and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301), and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In certain aspects, EUD 303 may be a client device, such as thin client, heavy client, mainframe computer, desktop computer and so on.

As defined herein, the term “client device” means a data processing system that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. Network infrastructure, such as routers, firewalls, switches, access points and the like, are not client devices as the term “client device” is defined herein. As defined herein, the term “user” means a person (i.e., a human being).

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304. As defined herein, the term “server” means a data processing system configured to share services with one or more other data processing systems.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

VCEs can be stored as “images,” and a new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other aspects, a private cloud 306 may be disconnected from the internet entirely (e.g., WAN 302) and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this aspect, public cloud 305 and private cloud 306 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

As another example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. Each block in the flowchart or block diagrams may represent a module, segment, or portion of instructions, which comprises one or more executable instructions for implementing the specified logical function(s).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” “one arrangement,” “an arrangement,” “one aspect,” “an aspect,” or similar language means that a particular feature, structure, or characteristic described in connection with the embodiment is included in at least one embodiment described within this disclosure. Thus, appearances of the phrases “one embodiment,” “an embodiment,” “one arrangement,” “an arrangement,” “one aspect,” “an aspect,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “if,” “when,” “upon,” “in response to,” and the like are not to be construed as indicating a particular operation is optional. Rather, use of these terms indicate that a particular operation is conditional. For example and by way of a hypothetical, the language of “performing operation A upon B” does not indicate that operation A is optional. Rather, this language indicates that operation A is conditioned upon B occurring.

The foregoing description is just an example of embodiments of the invention, and variations and substitutions. While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

What is claimed is:

1. A computer-implemented method within a computer hardware system including a machine learning engine, comprising:
monitoring a plurality of electronic communications between client devices including a first client device of a first user;
identifying, using the machine learning engine, ad-hoc tasks for the first user by performing natural language processing of the plurality of electronic communications;
monitoring platforms associated with the ad-hoc tasks to determine a task completion status of the identified ad-hoc tasks; and
automatically reserving, within a calendar/scheduling application of the first client device, a time slot for performing the ad-hoc tasks by the first user based upon a task velocity score.

2. The method of claim 1, wherein
the identifying the ad-hoc tasks includes identifying for each of the ad-hoc tasks:
an activity to be performed,
a platform with which the activity is to be performed, and
a user assigned to the activity.

3. The method of claim 2, wherein
the identifying the ad-hoc tasks further includes identifying for each of the ad-hoc tasks:
a timeframe during which the ad-hoc task is to be performed, and
an urgency level assigned to the ad-hoc task.

4. The method of claim 1, further comprising
training the machine learning engine based upon the identifying.

5. The method of claim 1, wherein
the task velocity score is determined based upon task velocity and task backlog.

6. The method of claim 1, wherein
a graphical user interface of the first client device is configured to allow the first user to select applications to be monitored for the electronic communications.

7. The method of claim 1, further comprising
pushing a notification to an application executing with the first client device based upon the application being a platform for performing at least one of the identified ad-hoc tasks.

8. The method of claim 1, wherein
the automatic reserving includes associating at least a portion of the identified tasks with the time slot.

9. A computer hardware system including a machine learning engine, comprising:
a hardware processor configured to perform the following executable operations:
monitoring a plurality of electronic communications between client devices including a first client device of a first user;
identifying, using the machine learning engine, ad-hoc tasks for the first user by performing natural language processing of the plurality of electronic communications;
monitoring platforms associated with the ad-hoc tasks to determine a task completion status of the identified ad-hoc tasks; and
automatically reserving, within a calendar/scheduling application of the first client device, a time slot for performing the ad-hoc tasks by the first user based upon a task velocity score.

10. The system of claim 9, wherein
the identifying the ad-hoc tasks includes identifying for each of the ad-hoc tasks:
an activity to be performed,
a platform with which the activity is to be performed, and
a user assigned to the activity.

11. The system of claim 10, wherein
the identifying the ad-hoc tasks further includes identifying for each of the ad-hoc tasks:
a timeframe during which the ad-hoc task is to be performed, and
an urgency level assigned to the ad-hoc task.

12. The system of claim 9, wherein the hardware processor is further configured to perform training the machine learning engine based upon the identifying.

13. The system of claim 9, wherein
the task velocity score is determined based upon task velocity and task backlog.

14. The system of claim 9, wherein
a graphical user interface of the first client device is configured to allow the first user to select applications to be monitored for the electronic communications.

15. The system of claim 9, wherein the hardware processor is further configured to perform
pushing a notification to an application executing with the first client device based upon the application being a platform for performing at least one of the identified ad-hoc tasks.

16. The system of claim 9, wherein
the automatic reserving includes associating at least a portion of the identified tasks with the time slot.

17. A computer program product, comprising:
a computer readable storage medium having stored therein program code,
the program code, which when executed by the computer hardware system including a machine learning engine, causes the computer hardware system to perform:
monitoring a plurality of electronic communications between client devices including a first client device of a first user;
identifying, using the machine learning engine, ad-hoc tasks for the first user by performing natural language processing of the plurality of electronic communications;
monitoring platforms associated with the ad-hoc tasks to determine a task completion status of the identified ad-hoc tasks; and
automatically reserving, within a calendar/scheduling application of the first client device, a time slot for performing the ad-hoc tasks by the first user based upon a task velocity score.

18. The computer program product of claim 17, wherein
the identifying the ad-hoc tasks includes identifying for each of the ad-hoc tasks:
an activity to be performed,
a platform with which the activity is to be performed,
a user assigned to the activity,
a timeframe during which the ad-hoc task is to be performed, and
an urgency level assigned to the ad-hoc task.

19. The computer program product of claim 17, wherein
the task velocity score is determined based upon task velocity and task backlog.

20. The computer program product of claim 17, wherein the program code further causes the computer hardware system to perform
pushing a notification to an application executing with the first client device based upon the application being a platform for performing at least one of the identified ad-hoc tasks.
